(19) United States
(12) Patent Application Publication
(10) Pub. No.: US 2004/0266422 A1
(43) Pub. Date: Dec. 30, 2004

(54) Method for providing call completion following a call to an improper called number in a wireless communications system

(76) Inventors: Karen Ann Hotze, Northfield, IL (US); Mark Alan McCormick, Naperville, IL (US)

Correspondence Address: Lucent Technologies Inc., Docket Administrator (Room 3J-219), 101 Crawfords Corner Road, Holmdel, NJ, 07733-3030, US

(21) Appl. No.: 10/609,993

(22) Filed: Jun. 30, 2003

(51) Int. Cl. H04Q 7/20

(52) U.S. Cl. 455/423; 455/418

(57) ABSTRACT

Methods are disclosed for completing wireless calls directed to an improper called number (such as may occur when an area code is changed or split) without requiring the caller to redial. A mobile switching center (MSC) analyzes dialed digits of a call to determine a projected called party/number. If the dialed digits do not comprise a proper called number, a proper calling number is derived from the dialed digits, the dialed digits are interpreted as a request to complete the call to the proper calling number and the call is completed to the projected called party. The call may be completed with or without an announcement.

### FIELD OF THE INVENTION

The present invention relates in general to communication systems, and in particular to wireless communications systems that on occasion, receive calls to improper dialing/directory numbers from calling parties.

### BACKGROUND OF THE INVENTION

Wireless communications systems are known to include Mobile Switching Centers (MSCs) for receiving calls from mobile stations such as cellular telephones and the like (operated by wireless subscribers), or from network devices (e.g., other MSCs or wireline switches) and for routing calls to other mobile stations or to wireline parties via an attached network, such as the Public Switched Telephone Network (PSTN). Generally, when a call is received, the MSC analyzes the received digits to determine whether they comprise a proper called number (i.e., the call contains an appropriate number of received digits and corresponds to a valid directory number of a called party). If so, the MSC completes the call to the called party. (It should be noted that a call may be misdialed, e.g., a “wrong number,” yet still be a proper called number as defined herein.) Occasionally, the MSC may receive calls directed to an improper called number (e.g., calls which dial or assume an invalid directory number or which do not contain the correct number of dialed digits). For example, improper called number(s) frequently occur in the instance when an area code of the PSTN has been changed or split into two or more distinct area codes, causing telephony devices in the affected area to assume a new area code. In such case, a calling party attempting to call a called party in the affected area may dial or assume (incorrectly) the former area code rather than the new area code. Depending on the phase of transition from the former area code to the new area code, the MSC might allow completion of such a call (i.e., during a first phase of transition where the former area code is still considered a proper called number) or terminate the call. Termination of the call may be accompanied by an announcement (e.g., during a second phase of transition) or the call may be terminated without announcement (e.g., during a third phase of transition). The announcement, if provided, may include an identification of the new area code and may further include an indication of call treatment following the announcement.

Presently, however, call treatment options do not allow for completing the call to the called party following a call to an improper called number. With or without an announcement, such calls are either terminated or routed to a third party platform (e.g., service center) even in instances (such as the above described scenario of an area code split) where the MSC can derive the correct directory number of the called party. Thereafter, a caller must either re-dial the called party using the correct number or rely upon the third party to re-route the call to the called party via the MSC or appropriate switching element. These options are inconvenient to the caller as well as to the service provider in terms of time wasted and inefficient use of network resources. Moreover, in certain jurisdictions (e.g., Canada), substantial fines may be levied against service providers for failing to complete calls to the called party following an announcement in the context of an area code split.

Accordingly, there is a need for a method that allows for completing calls dialed or assuming an improper called number, most particularly in situations where the called party (and hence, the correct directory number) can be determined from the improper number. Advantageously, the method may be employed in the scenario of a changed or split area code to allow for completing calls dialed using the former area code with or without an announcement, without requiring the calling party to re-dial and without allocating inter-switch trunks in an inefficient manner. Advantageously, the method will provide for recognizing certain instances when an announcement should be played and, in such case, to provide the announcement and complete the call to the called party using the original dialed number.

### SUMMARY OF THE INVENTION

This need is addressed and a technical advance is achieved in the art by a method that provides for completing calls from a calling party to a called party even in cases where the calling party has dialed or assumed an improper called number (such as where the calling party has dialed or assumed a former area code of the called party). Optionally, the method provides for selecting and playing appropriate announcements (e.g., indicating the correct area code or proper called number) and for completing call(s) following the announcements without requiring the caller(s) to redial. The method provides for greatly improved revenue generation using fewer resources and further provides for increased customer satisfaction.

In one embodiment, a mobile switching center, responsive to receiving a call from a mobile station comprising a series of dialed digits, analyzes the digits to identify a projected called party. The dialed digits need not comprise a proper called number of the projected called party. If the dialed digits do not comprise a proper calling number (e.g., if the digits include or assume a former area code of the projected called party), the mobile switching center derives a proper calling number (e.g., having the proper area code), interprets the dialed digits as a proxy for the proper calling number and completes the call to the projected called party. The call may be completed with or without an announcement.

### BRIEF DESCRIPTION OF THE DRAWINGS

FIG. 1 is a block diagram of a wireless communications system in which embodiments of the present invention may be implemented;

FIG. 2 is a flowchart of a method for processing an incoming call from a mobile station in the system of FIG. 1, whereby the incoming call may be directed to an improper called number;

FIG. 3 is a block diagram of a wireless communication system attached to an external network in which embodiments of the present invention may be implemented; and

FIG. 4 is a flowchart of a method for processing an incoming call received from the external network in the system of FIG. 3, whereby the incoming call may be directed to an improper called number.

### DESCRIPTION OF THE PREFERRED EMBODIMENTS

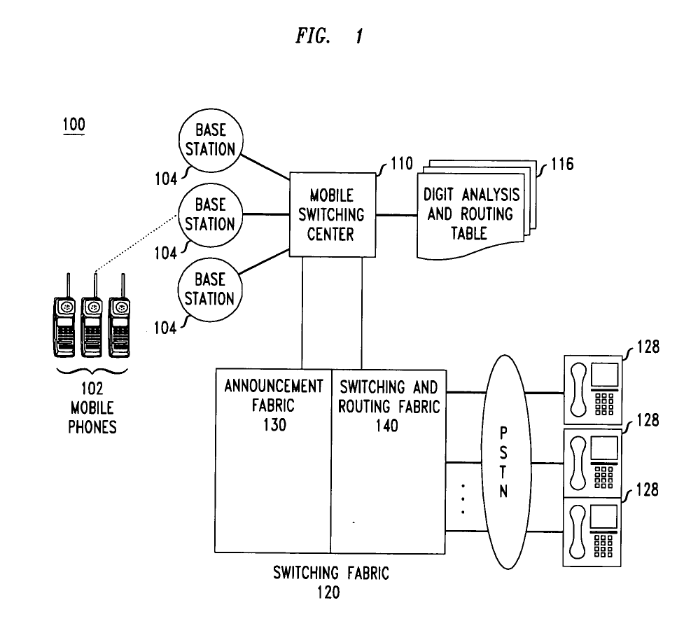

FIG. 1 depicts a wireless communications system 100 adapted for receiving and routing calls from mobile stations 102, such as cellular telephones, pagers, personal digital assistant, wireless-equipped personal computers and the like. Generally, as is well known, a mobile station initiates a call by entering a sequence of digits (hereinafter termed dialed digits) and pressing the send button from an associated keypad. The dialed digits typically comprise at least a portion of a unique directory number (DN) of a called party device, which may comprise for example, another mobile station or a wireline device.

Typically, the set of digits necessary to identify a called party device will differ based on the relative location of the calling party and called party, i.e. where they are situated relative to each other's area code. For example, when both the calling and called party are within an area served by the same area code (i.e., a local call), a set of seven dialed digits comprising a three digit office code and a four digit line code will suffice to identify the called party. That is, the three digit area code is assumed for a local call and need not be dialed. As another example, when the calling and called party are not in the same area code but are within the same LATA boundary (i.e., an intra-LATA call), a set of 10 dialed digits comprising a three digit area code, three digit office code and a four digit line code is necessary to identify the calling party. As yet another example, when the called party and the calling party reside in different LATAs and reside in different area codes or countries a DN greater than 10 digits must be dialed. In such case, the DN comprises a country code (1-3 digits, typically a “1” for mobiles homed in the United States of America) followed by a three digit area code, a three digit office code and a four digit line code.

As will be appreciated, in any of the previous examples, a service provider may allow mobile station subscriber(s) to dial a shortened number from which the full DN can be identified. For example, a given mobile station subscriber may be allowed to dial just the four digit line code (or any number of digits up to the complete DN) to identify a called party.

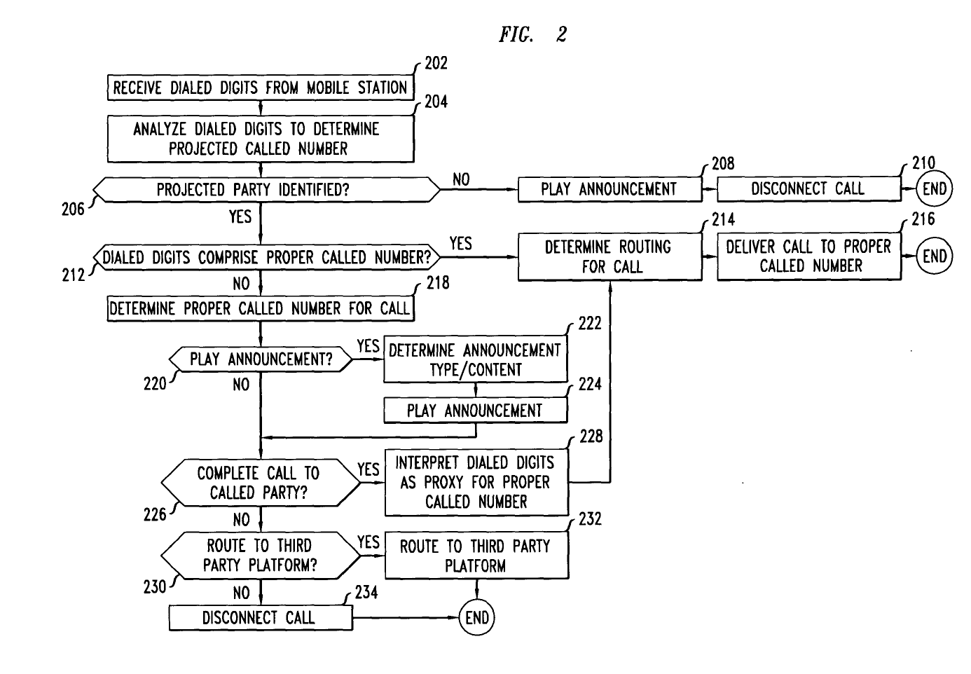

The mobile station(s) 102 communicate the dialed digits, along with various other control, signaling and authentication information to one or more base stations 104. The base stations 104 are connected to and controlled by a Mobile Switching Center (MSC) 110. As will be described in greater detail in relation to FIG. 2, the MSC 110 consults one or more Digit Analysis and Routing databases 116 to analyze the received digits and determine the routing of the called number through the network to its final destination. The MSC 110 communicates with a Switching Fabric 120 to assign announcement circuits and/or routing instructions. The Switching Fabric 120 is comprised of an Announcement Fabric 130 and a Routing Fabric 140. The Announcement Fabric 130 provides circuits that are used to play announcements, when necessary, to the calling mobile subscriber. The Routing Fabric 140 is comprised of circuits necessary to route the call through trunks, IP circuits or ATM channels towards a destination. The Switching Fabric 120 is connected to the Public Switched Telephone Network (PSTN) 150 via trunks 160 or other physical media. Alternatively or additionally, the Switching Fabric 120 may be connected to Private Networks (PNs) (not shown). The PSTN (and PNs, as may be appropriate) are connected via known routes and trunks to end-user telephones 128. The telephones 128 may comprise, for example ISDN phones, SIP phones, POTS phones, etc.

Referring now to FIG. 2 there is shown a method for use in the system described in FIG. 1 to process an incoming call. The steps of FIG. 2 are implemented, where applicable, by the MSC 110 using a processor (not shown) executing stored subroutines and retrieving provisioned data within an associated memory (not shown). At step 202, the MSC 110 receives a set of dialed digits from a mobile station 102. The dialed digits may include 7 digits, 10 digits, 11 digits or generally any other number of digits that are dialed by the calling party.

At step 204, the MSC 110 analyzes the dialed digits to determine a projected called number. In one embodiment this is accomplished by a series of reads of database forms from the Digit Analysis and Routing Table 116 wherein each iteration provides a portion of the key to obtain further information to determine the projected called number. The projected called number defines a number that is assumed to be targeted by the calling party.

In the simplest case, the projected called number corresponds exactly to the dialed digits. For example, if a caller dials the number (312) 555-1234 (i.e., comprising the area code 312, office code 555 and line code 1234) and the number is a valid number in the database, the dialed number becomes the projected called number. The projected number might also include an assumed area code. For example, if a caller in the 312 area code dials the number 555-1234, the MSC 110 assumes in a first iteration that 312 is the intended area code and compares to the database. If the number (312) 555-1234 is a valid number in the database, it becomes the projected called number. If the number is not a valid number, additional iteration(s) are performed as necessary to determine a projected number (or until the MSC determines it is unable to determine a projected number).

For example, consider a call that dials or assumes an incorrect area code because the area code of the called party has changed, e.g., the caller dials a former number of the called party (312) 555-1234 but the current number of the called party is now (630) 555-1234. In one embodiment, the MSC recognizes that the 312 area code is changed and substitutes the current area code to determine the projected number. Thus, in the above example, the projected number becomes (630) 555-1234.

It should be noted, the dialed number (312) 555-1234 including the former area code may still be a “proper number” as defined herein in a first phase of transition (i.e., where both the old and new numbers are considered valid numbers) but becomes an improper number in a second or third phase of transition (i.e., where only the new number is considered a valid number). As will be appreciated, during the first phase of transition where either number is proper, it is a matter of design choice whether the projected number includes the old or new area code. The MSC may substitute the current area code to determine the projected number (e.g., (630) 555-1234) as has been described; or alternatively, the MSC may determine the projected number to include the dialed digits (e.g., (312) 555-1234).

At step 206, the MSC 110 in conjunction with the Digit Analysis and Routing Table 116 determines if a projected party can be identified. A projected party is defined as a called party individual or device corresponding to the projected called number (e.g., the number (630) 555-1234 corresponds to “John Doe.”) As will be appreciated, the MSC 110 may be unable to identify a projected party if the dialed digits are misdialed, if they include an incorrect number of digits, etc. or if the projected number is unassigned. In such case, the MSC 110 causes an announcement to be played at step 208 to inform the caller that the call can not be completed as dialed. For example, the announcement may state: “The digits you dialed may not be routed. Please check your number and try again.” The call is then disconnected at step 210.

Once a projected party is identified, the call may be routed to the projected party without requiring the caller to re-dial, whether the caller has dialed a proper number or improper number. In one embodiment, having identified the projected called party at step 206, the MSC determines at step 212 whether the dialed digits comprises a proper called number of the projected party. As will be appreciated, this determination may alternatively be made in conjunction with step 204 prior to identifying a called party. As has been noted, a proper called number is defined as one that corresponds to a valid, complete directory number and can be routed to the projected party without further manipulation of the dialed digits. If the dialed digits are determined at step 212 to comprise a proper called number, routing for the call is determined at step 214 and the call is delivered to the proper called number (destination) at step 216.

If the dialed digits are determined at step 212 to not comprise a proper number, the MSC determines at step 218 a proper number for the call. In one embodiment, the step of determining a proper number comprises retrieving the projected number determined at step 204, determining if the projected number is a proper number and either recognizing the projected number as a proper number (i.e., if the projected number is a proper number) or deriving a proper number from the projected number (i.e., if the projected number is not a proper number).

Thus, continuing the previous example where the caller dials a former number of a called party (312) 555-1234 and the MSC has identified the projected number as (630) 555-1234, the step of determining a proper number comprises determining whether the number (630) 555-1234 is a proper number. If it is a proper number, the MSC recognizes it as such. If it is not a proper number (however defined), the MSC derives a proper number from provisioned data by adding or removing digits to the projected number as may be required. Generally, of course, the step of deriving the proper number from the projected number will depend on how many digits are in the projected number and how many digits define a proper number. For example, if the proper number requires 11 digits, the MSC may add a “1” prefix to the 10-digit projected number, resulting in a proper number 1-630-555-1234; if the proper number requires 7 digits, the MSC may remove the “630” area code from the 10-digit projected number to derive the proper number 555-1234.

Having determined the proper number, the MSC determines at step 220 whether to play an announcement to the initiator of the call. If an announcement is to be played, the announcement type and content is determined at step 222 and the announcement is played to the initiator of the call at step 224. For example, an announcement may be desired to inform the mobile subscriber of the proper area code for the number that was dialed. In such case, the announcement might state: “The area code for the called number has been changed. Please make a note of the new area code and use it for future calls to this called number.”

Upon completion of the announcement or if no announcement is required to be played, it is determined at step 226 if the call will be completed to the called party. In one embodiment, if the call is to be completed, the dialed digits are interpreted as a proxy for the proper called number at step 228. That is, having determined a projected number from the dialed digits at step 204 and translating the projected number to a proper number at step 218, the call is completed at step 228 without requiring the caller to redial, by interpreting the dialed digits as a request for the proper number. Routing for the call is determined at step 214 based on the proper number and the call is delivered to the proper called number (destination) at step 216.

If the call is not to be completed to the called party, it is determined at step 230 whether the call is to be routed to a third party platform. (e.g., service center). If so, the call is routed to the third party platform at step 232. In one embodiment, the routing is determined via provisioned data. If the call is determined not to be routed to a third party platform, the call is disconnected at step 234.

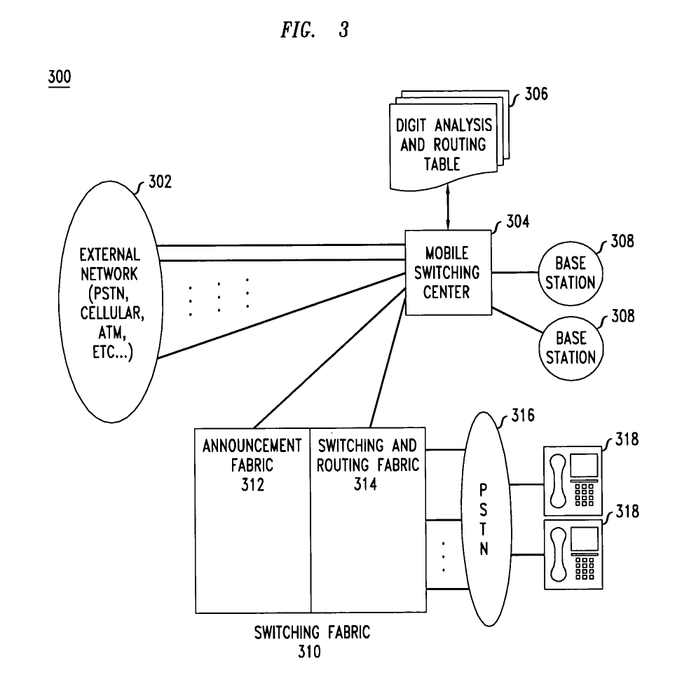

Now turning to FIG. 3, there is shown a wireless communications system 300 adapted for receiving and routing calls from an external network 302 such as the PSTN, MSCs, Cellular Gateways and the like. Generally, as is well known, a network entity sends a call towards a final destination by sending signaling messages. These messages contain a sequence of digits (hereinafter termed incoming digits.) The incoming digits typically comprise at least a portion of a unique directory number (DN) of a called party device, which may comprise for example, a mobile station or a wireline device.

Similar to the “dialed digits” described in relation to FIG. 1, the set of incoming digits necessary to identify a called party device will differ based on the relative location of the calling party and called party, i.e. where they are situated relative to each other's area code. Although typically, the complete DN is available in the incoming digits, the length of digits may be shortened to allow for shorter messages and/or faster pulsing of the digits through the network 302. For example, when both the calling and called party are within an area served by the same area code (i.e., local call), a set of seven incoming digits comprising a three digit office code and a four digit line code will suffice to identify the called party. That is, the three digit area code is assumed for a local call and need not be forwarded in the signaling message. As another example, when the calling and called party are not in the same area served by the same area code but are within the same LATA boundary (i.e., Intra-Lata call), a set of 10 incoming digits comprising a three digits area code, three digit office code and a four digit line code is necessary to identify the calling party. As yet another example, when the called party and the calling party reside in different LATAs and reside in different area codes or countries the DN is greater than 10 digits. In such case the DN comprises a country code (1-3 digits, typically a “1” for those mobiles homed in the United States of America) followed by a three digit area code, a three digit office code and a four digit line code.

As will be appreciated, in any of the previous examples, a service provider may allow another entity to send the incoming digits as a shortened number from which the full DN can be identified.

The network 302 communicates the incoming digits, along with various other signaling information to a Mobile Switching Center (MSC) 304. The MSC 304 consults one or more Digit Analysis and Routing databases 306 to determine the validity of the incoming digits and the routing of the incoming call through the network to its final destination. The MSC 304 communicates with the Switching Fabric 310 to assign announcement circuits and/or routing instructions. The Switching Fabric 310 is comprised of the Announcement Fabric 312 and the Routing Fabric 314. The Announcement Fabric 312 provides the circuits that are used to play announcements, when necessary, to the mobile subscriber. The Routing Fabric 314 is comprised of the circuits necessary to route the call through trunks, IP circuits or ATM channels towards a destination. The order of database entries retrieved is determined in the MSC 304 and is used to determine how to assign announcements circuits in the Announcement Fabric 312 and the Routing Fabric 314 that are controlled in the Switching Fabric 310. The Switching Fabric 310 is connected to the Public Switched Telephone Network (PSTN) 316 and Private Networks (PNs) (not shown) via trunks 320 and other physical media. The PSTN and PNs are then connected via known routes and trunks to end-user telephones 318. The telephones may comprise for example ISDN phones, SIP phones, POTS phones, etc.

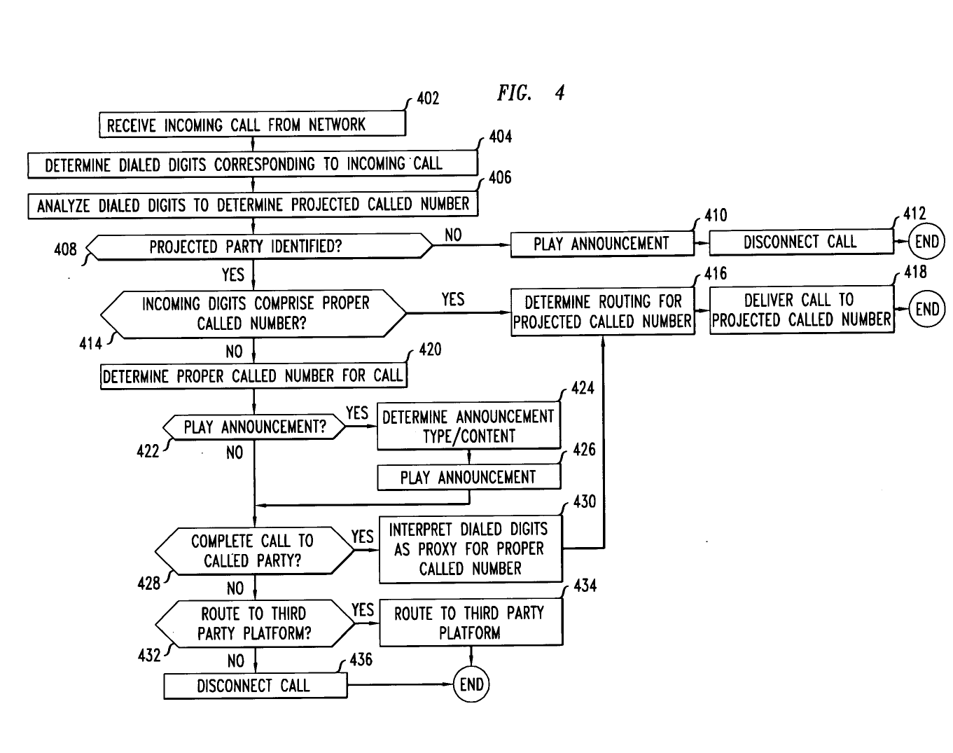

Referring now to FIG. 4 there is shown a method for use in the system described in FIG. 3 to process an incoming call from the network. The steps of FIG. 4 are implemented, where applicable, by executing stored subroutines using provisioned data within a suitable processor (not shown) and/or memory (not shown) within the MSC 304.

At step 402, the MSC 304 receives an incoming call from the network 302. The MSC 304 determines the incoming digits corresponding to the incoming call at step 404. The incoming call may contain any number of digits that would distinguish the destination of a destination party, e.g. 7 digits, 10 digits, 11 digits or any other length of digits that may be recognized and converted to a projected called number. The MSC 304 analyzes the incoming digits to determine the projected called number at step 406. In one embodiment this is accomplished by a series of reads of database forms wherein each entry read provides at least one portion of the key to obtain further information to determine the projected called number. During the applying of the provisioned data, it is determined if the projected called number corresponds to an identifiable party (“projected party”) at step 408. If not, the MSC 304 causes an announcement to be played at step 410 to indicate to the initiator of the call that the call can not be completed as dialed. For example the announcement may state: “The number you dialed can not be routed. Please check the number and try again.” The call is then disconnected at step 412.

If, at step 408, a projected party can be identified, the MSC 304 determines at step 414 whether the incoming digits comprise a proper called number of the projected party. A proper called number is defined as one that is complete and can be routed to the projected party without further manipulation of the dialed digits. For example, a set of seven digits are received in the incoming call, upon adding the area code of the calling party the call is able to be routed to the final destination; although the correct final area code may be different than the assumed area code. If the incoming digits are determined to comprise a proper called number, routing for the call is determined at step 416 and the call is delivered to the proper called number (destination) at step 418.

If, at step 414, the incoming digits are determined to not comprise a proper called number, the MSC 304 performs further processing of the incoming digits, at step 420, to determine a proper called number. In one embodiment, the proper called number is derived from provisioned data to complete the call to the proper destination. Upon determination of the number, a decision is made at step 422, whether to play an announcement to the initiator of the call. If an announcement is to be played, the announcement type and content is determined at step 424 and the announcement is played to the initiator of the call at step 426. For example, the announcement may provide to the calling party information concerning the proper area code for the number that was dialed. As an example, the announcement may state: “The area code for the number called has been changed. Please make a note of the new area code and use it for future calls to this number.”

Upon completion of the announcement or if no announcement is required to be played, it is determined at step 428, if the call will be completed to the called party. If the call is to be completed, the incoming digits are interpreted as a proxy for the proper called number at step 430. The proxy being a set of digits that can be translated to a final destination. The number that is dialed is translated and the subsequent digits are used in the routing of the call. The routing for the proper called number is determined at step 416 and the call is delivered to the proper called number (destination) at step 418.

If the call is not to be completed to the called party, it is determined whether the call is to be routed to a third party platform at step 432. If so, at step 434, the call is routed to a third party platform. In one embodiment, the routing is determined via provisioned data. If the call is determined not to be routed to a third party platform, at step 436 the call is disconnected.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for use in a wireless communication system comprising:
receiving a call comprising a series of digits;
analyzing the digits to identify a projected called party;
determining whether the series of digits comprises a proper calling number of the projected called party;
if the series of digits does not comprise a proper calling number,
determining a proper calling number;
interpreting the digits as a proxy for the proper calling number; and
completing the call to the projected called party.

2. The method of claim 1, further comprising:
if the series of digits does not comprise a proper calling number, playing an announcement prior to completing the call to the projected called party.

3. The method of claim 1, further comprising:
if the series of digits does not comprise a proper calling number, completing the call to the projected called party without an announcement.

4. The method of claim 1, wherein the step of receiving a call comprises receiving a series of digits including an office code and line code, the step of analyzing the digits comprises identifying the projected called party from the office code and line code.

5. The method of claim 4, wherein the step of analyzing the digits comprises assuming an area code for the call, yielding an assumed area code.

6. The method of claim 5, wherein the step of determining comprises:
determining if the assumed area code is a current area code of the projected called party; and
if the assumed area code is not a current area code of the projected called party, determining that the series of digits does not comprise a proper calling number.

7. The method of claim 1, wherein the step of receiving a call comprises receiving a series of digits including an area code, office code and line code, the step of analyzing the digits comprises identifying the projected called party from the office code and line code.

8. The method of claim 7, wherein the step of determining comprises:
determining if the area code is a current area code of the projected called party; and
if the area code is not a current area code of the projected called party, determining that the series of digits does not comprise a proper calling number.

9. A method for use in a wireless communication system comprising:
receiving a call comprising a series of digits;
analyzing the digits to identify a projected called party;
determining if the series of digits include or assume a former area code of the projected called party;
if the series of digits include or assume a former area code of the projected called party,
determining a current area code of the projected called party;
interpreting the digits as a proxy for a calling number including the current area code; and
completing the call to the projected called party.
